(19) United States
(12) Patent Application Publication
(10) Pub. No.: US 2008/0059483 A1
(43) Pub. Date: Mar. 6, 2008

(54) API-ACCESSIBLE MEDIA DISTRIBUTION SYSTEM

(75) Inventors: Robert John Williams, San Francisco, CA (US); Stuart H. Statman, Seattle, WA (US); Joshua Daniel Wright, Seattle, WA (US)

Correspondence Address: HOLLAND & KNIGHT LLP, 10 ST. JAMES AVENUE, BOSTON, MA, 02116, US

(73) Assignee: RealNetworks, Inc., Seattle, WA (US)

(21) Appl. No.: 11/848,844

(22) Filed: Aug. 31, 2007

Related U.S. Application Data
(60) Provisional application No. 60/842,056, filed on Aug. 31, 2006.
(60) Provisional application No. 60/843,212, filed on Sep. 8, 2006.

(51) Int. Cl. G06F 17/30

(52) U.S. Cl. 707/10; 707/E17.001

(57) ABSTRACT

A media distribution system, method, and computer program product for storing a plurality of media data files within a media repository. One or more of the plurality of media data files are identified within a file catalog. A data request is received, using a standardized protocol, from a client electronic device. Data is provided, in response to the received data request, to the client electronic device in a third party usable format. A user of the client electronic device is enabled to browse/search the file catalog and identify one or more media data files chosen from the plurality of media data files.

### RELATED APPLICATION(S)

This application claims the benefit of the following application(s): U.S. Provisional Patent Application No. 60/842,056, entitled “API-Accessible Media Distribution System”, filed 31 Aug. 2006, and U.S. Provisional Patent Application No. 60/843,212, entitled “API-Accessible Media Distribution System”, filed 8 Sep. 2006.

### TECHNICAL FIELD

This disclosure relates to media distribution systems and, more particularly, to API-accessible media distribution systems.

### BACKGROUND

Media distribution systems (e.g., the Rhapsody™ service offered by RealNetworks, Inc. of Seattle, Wash.) distribute media data files to a user's client electronic device (e.g., a personal media player, a personal digital assistant, or a multimedia cellular telephone) from a media server. A media distribution system may distribute media data files by allowing a user to e.g., receive downloaded media data files and/or stream remote media data files.

Unfortunately, a dedicated client application is often required to access a media distribution system. Further, as this dedicated client application is typically executed on a personal computer (e.g., a desktop computer or a laptop computer), the media distribution system may not be directly accessible by the client electronic device.

### SUMMARY OF DISCLOSURE

In a first implementation, a media distribution system includes a media repository for storing a plurality of media data files and a file catalog that identifies one or more of the plurality of media data files. An application program interface enables a user of a client electronic device to browse/search the file catalog and identify one or more media data files chosen from the plurality of media data files. The application program interface is configured to: receive a data request, using a standardized protocol, from the client electronic device; and provide data, in response to the received data request, to the client electronic device in a third party usable format.

One or more of the following features may be included. The standardized protocol may be chosen from the group consisting of: Simple Object Access Protocol (SOAP); Java Script Object Notation (JSON); REpresentational State Transfer (REST); and extensible Markup Language Remote Procedure Protocol (XML-RPC).

Providing data, in response to the received data request, to the client electronic device in a third party usable format may include providing, to the client electronic device, a service description that describes how the client electronic device may communicate with the media distribution system. The service description may be a Web Services Description Language (WSDL).

The client electronic device may be configured to process the service description to generate one or more client stubs for accessing the media distribution system. The application program interface may include one or more servers stubs that are configured to communicate with one or more client stubs.

In another implementation, a method includes storing a plurality of media data files within a media repository. One or more of the plurality of media data files are identified within a file catalog. A data request is received, using a standardized protocol, from a client electronic device. Data is provided, in response to the received data request, to the client electronic device in a third party usable format. A user of the client electronic device is enabled to browse/search the file catalog and identify one or more media data files chosen from the plurality of media data files.

One or more of the following features may be included. The standardized protocol may be chosen from the group consisting of: Simple Object Access Protocol (SOAP); Java Script Object Notation (JSON); REpresentational State Transfer (REST); and eXtensible Markup Language Remote Procedure Protocol (XML-RPC).

Providing data, in response to the received data request, to the client electronic device in a third party usable format may include providing, to the client electronic device, a service description that describes how the client electronic device may communicate with the media distribution system. The service description may be a Web Services Description Language (WSDL).

The client electronic device may be configured to process the service description to generate one or more client stubs for accessing the media distribution system.

In another implementation, a computer program product resides on a computer readable medium that has a plurality of instructions stored on it. When executed by a processor, the instructions cause the processor to perform operations including storing a plurality of media data files within a media repository. One or more of the plurality of media data files are identified within a file catalog. A data request is received, using a standardized protocol, from a client electronic device. Data is provided, in response to the received data request, to the client electronic device in a third party usable format. A user of the client electronic device is enabled to browse/search the file catalog and identify one or more media data files chosen from the plurality of media data files.

One or more of the following features may be included. The standardized protocol may be chosen from the group consisting of: Simple Object Access Protocol (SOAP); Java Script Object Notation (JSON); REpresentational State Transfer (REST); and eXtensible Markup Language Remote Procedure Protocol (XML-RPC).

Providing data, in response to the received data request, to the client electronic device in a third party usable format may include providing, to the client electronic device, a service description that describes how the client electronic device may communicate with the media distribution system. The service description may be a Web Services Description Language (WSDL).

The client electronic device may be configured to process the service description to generate one or more client stubs for accessing the media distribution system.

The details of one or more implementations are set forth in the accompanying drawings and the description below. Other features and advantages will become apparent from the description and the drawings.

### BRIEF DESCRIPTION OF THE DRAWINGS

FIG. 1 is a diagrammatic view of a media distribution system, a client application, a proxy application, and a personal media device coupled to a distributed computing network;

FIG. 2 is an isometric view of the personal media device of FIG. 1;

FIG. 3 is a diagrammatic view of the personal media device of FIG. 1;

FIG. 4 is a diagrammatic view of a data exchange with the media distribution system of FIG. 1; and

FIG. 5 is a flowchart of a process executed by the media distribution system of FIG. 1.

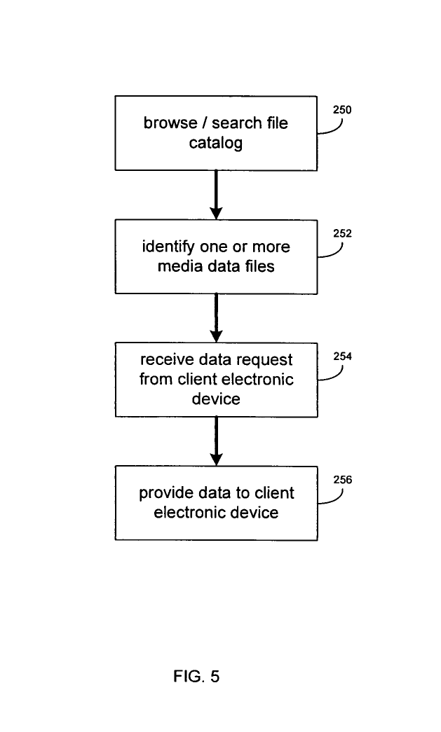

### DETAILED DESCRIPTION OF EXEMPLARY EMBODIMENTS

System Overview:

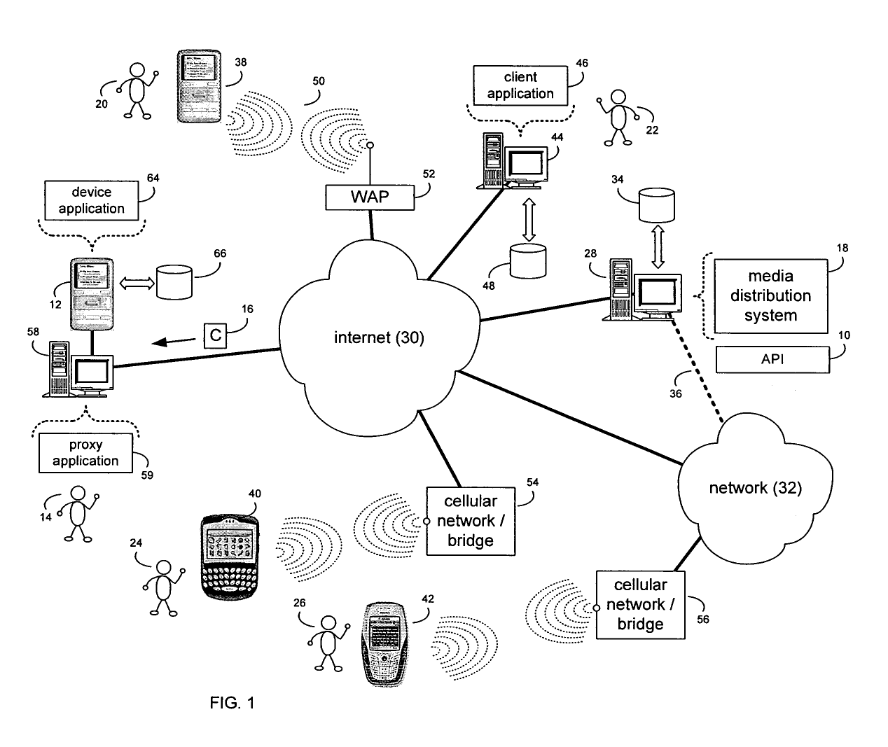

Referring to FIG. 1, there is shown an API (i.e., Application Programming Interface) 10 that allows e.g., personal media device 12 (and, therefore, user 14) to obtain media content 16 from media distribution system 18. Media content 16 may be, for example, digitally-encoded audio and/or video media data files that may be compressed using known compression techniques. Examples of such compression techniques may include but are not limited to MPEG-1, MPEG-2, MPEG-4, H.263, H.264, Advanced Audio Coding, and other techniques promulgated by the International Standards Organization (ISO) and the Motion Picture Experts Group (MPEG).

Examples of the format of the media content 16 received from media distribution system 18 may include: purchased downloads received from media distribution system 18 (i.e., media content licensed to e.g., user 14 for use in perpetuity); subscription downloads received from media distribution system 18 (i.e., media content licensed to e.g., user 14 for use while a valid subscription exists with media distribution system 18); and media content streamed from media distribution system 18, for example. Typically, when media content is streamed from e.g., computer 28 to personal media device 12, a copy of the media content is not permanently retained on personal media device 12. In addition to media distribution system 18, media content may be obtained from other sources, examples of which may include but are not limited to files ripped from music compact discs.

Examples of the types of media content 16 distributed by media distribution system 18 include: audio media data files (examples of which may include but are not limited to music files, audio news broadcasts, audio sports broadcasts, and audio recordings of books, for example); video media data files (examples of which may include but are not limited to video footage that does not include sound, for example); audio/video media data files (examples of which may include but are not limited to a/v news broadcasts, a/v sports broadcasts, feature-length movies and movie clips, music videos, and episodes of television shows, for example); and multimedia content media data files (examples of which may include but are not limited to interactive presentations and slideshows, for example).

Media distribution system 18 may provide media data streams and/or media data files to a plurality of users (e.g., users 14, 20, 22, 24, 26). Examples of such a media distribution system 18 may include the Rhapsody™ service offered by RealNetworks, Inc. of Seattle, Wash.

Media distribution system 18 may be a server application that resides on and is executed by computer 28 (e.g., a server computer) that is connected to network 30 (e.g., the Internet). Computer 28 may be a web server running a network operating system, examples of which may include but are not limited to Microsoft Windows XP Server™, Novell Netware™, or Redhat Linux™.

Computer 28 may also execute a web server application, examples of which may include but are not limited to Microsoft IIS™, Novell Webserver™, or Apache Webserver™, that allows for HTTP (i.e., HyperText Transfer Protocol) access to computer 28 via network 30. Network 30 may be connected to one or more secondary networks (e.g., network 32), such as: a local area network; a wide area network; or an intranet, for example.

The instruction sets and subroutines of media distribution system 18 and API 10, which may be stored on a storage device 34 coupled to computer 28, may be executed by one or more processors (not shown) and one or more memory architectures (not shown) incorporated into computer 28. Additionally, the media data file available from media distribution system 18 may be stored on e.g., storage device 34 attached to computer 28. Storage device 34 may include but is not limited to a hard disk drive, a tape drive, an optical drive, a RAID array, a random access memory (RAM), or a read-only memory (ROM).

Users 14, 20, 22, 24, 26 may access media distribution system 18 through e.g., network 30 and/or secondary network 32. Further, computer 28 (i.e., the computer that executes media distribution system 18) may be connected to network 30 through secondary network 32, as illustrated with phantom link line 36.

Media distribution system 18 may be accessed directly or may be accessed through a proxy computer. For example, users 20, 24, 26 may directly access media distribution system 18 through various client electronic devices, examples of which may include, but are not limited to: personal media device 38; personal digital assistant 40; cellular telephone 42; televisions (not shown); cable boxes (not shown); internet radios (not shown); or dedicated network devices (not shown); for example. Additionally/alternatively, media distribution system 18 may be directly accessed via client computer 44.

Additionally, the devices directly accessing media distribution system 18 may be directly coupled to network 30 (or network 32). For example, client computer 44 is shown directly coupled to network 30 via a hardwired network connection. Further, client computer 44 may execute a client application 46 (examples of which may include but are not limited to Microsoft Internet Explorer™ available from Microsoft Inc, of Redmond, Wash., Netscape Navigator™, Rhapsody™ client & RealPlayer™ client available from RealNetworks, Inc. of Seattle, Wash., or a specialized interface) that allows e.g., user 22 to access and configure media distribution system 18 via network 30 (or network 32). Client computer 44 may run an operating system, examples of which may include but are not limited to Microsoft Windows XP™, or Redhat Linux™.

The instruction sets and subroutines of client application 46, which may be stored on a storage device 48 coupled to client computer 44, may be executed by one or more processors (not shown) and one or more memory architectures (not shown) incorporated into client computer 44. Storage device 48 may include but is not limited to a hard disk drive, a tape drive, an optical drive, a RAID array, a random access memory (RAM), or a read-only memory (ROM).

Alternatively, the devices directly accessing media distribution system 18 may be indirectly coupled to network 30 (or network 32). For example, personal media device 38 is shown wirelessly coupled to network 30 via a wireless communication channel 50 established between personal media device 38 and wireless access point (i.e., WAP) 52, which is shown directly coupled to network 30. WAP 52 may be, for example, an IEEE 802.11a, 802.11b, 802.11g, Wi-Fi, and/or Bluetooth device that is capable of establishing communication channel 50 between personal media device 38 and WAP 52.

As is known in the art, the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Additionally, personal digital assistant 40 is shown wirelessly coupled to network 30 via cellular/network bridge 54 (which is shown directly coupled to network 30); and cellular telephone 42 is shown wirelessly coupled to network 32 via a cellular/network bridge 56 (which is shown directly coupled to network 32).

In addition to directly accessing media distribution system 18, client electronic devices may indirectly access media distribution system 18 through a proxy computer. For example, personal media device 12 is shown to access media distribution system 18 through proxy computer 58. Proxy computer 58 may execute proxy application 59. which may have functionality similar to that of client application 46.

Client Electronic Devices:

As discussed above, examples of client electronic devices may include personal media devices 12, 38, personal digital assistant 40, and cellular telephone 42. Accordingly, while the following disclosure is directed towards personal media device 12, 38, it is understood that the following disclosure may be equally applied to any client electronic device (including personal digital assistant 40, cellular telephone 42, televisions (not shown); cable boxes (not shown); internet radios (not shown); and dedicated network devices (not shown).

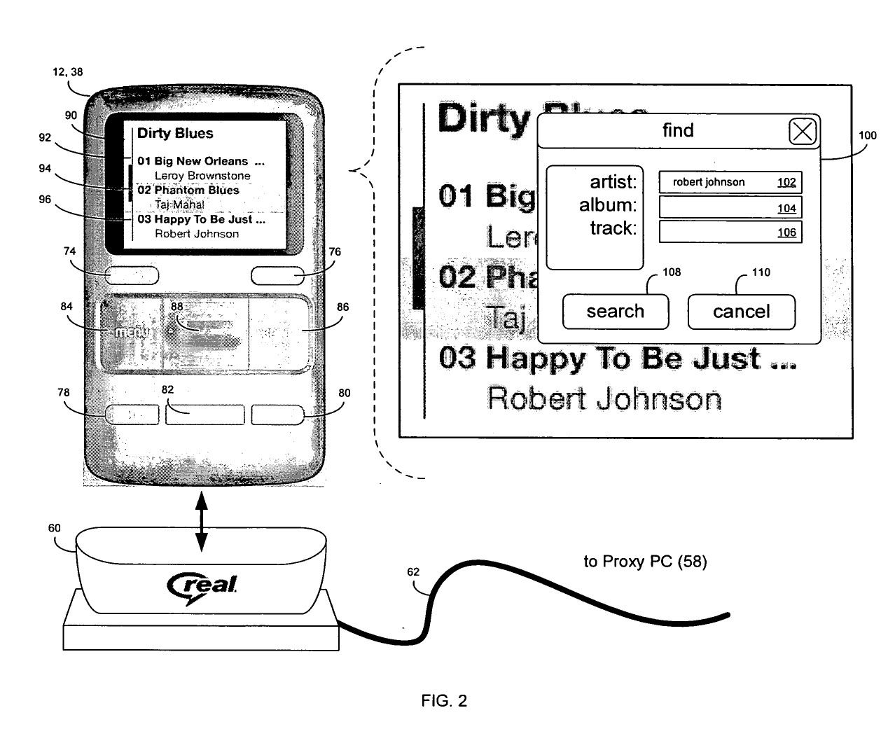

Referring also to FIG. 2, personal media device 12, 38 may be connected to e.g., proxy computer 58 via a docking cradle 60. Typically, personal media device 12, 38 includes a bus interface (to be discussed below in greater detail) that couples personal media device 12, 38 to docking cradle 60. Docking cradle 60 may be coupled (with cable 62) to e.g., a Universal Serial Bus (i.e., USB) port, a serial port, or an IEEE 1394 (i.e., FireWire) port included within proxy computer 58. For example, the bus interface included within personal media device 12, 38 may be a USB interface, and docking cradle 60 may function as a USB hub (i.e., a plug-and-play interface that allows for “hot” coupling and uncoupling of personal media device 12, 38 and docking cradle 60).

Proxy computer 58 may function as an Internet gateway for personal media device 12, 38. For example, through the use of e.g., the universal plug and play protocol (i.e., UPnP), personal media device 12, 38 may use proxy computer 58 to access media distribution system 18 via network 30 (and network 32) and obtain media content 16. Specifically, upon receiving a request for media distribution system 18 from personal media device 12, 38, proxy computer 58 (acting as an Internet client on behalf of personal media device 12, 38), may request the appropriate web page/service from computer 28 (i.e., the computer that executes media distribution system 18). When the requested web page/service is returned to proxy computer 58, proxy computer 58 relates the returned web page/service to the original request (placed by personal media device 12, 38) and forwards the web page/service to personal media device 12, 38. Accordingly, proxy computer 58 may function as a conduit for coupling personal media device 12, 38 to computer 28 and, therefore, media distribution system 18.

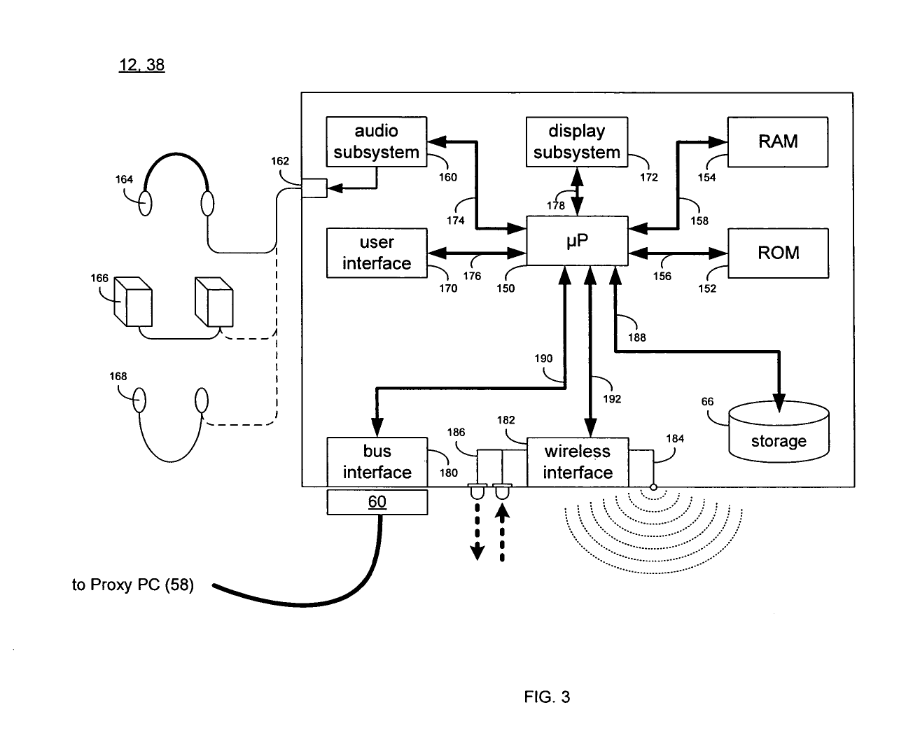

Referring also to FIG. 3, a diagrammatic view of personal media device 12, 38 is shown. Personal media device 12, 38 may include microprocessor 150 (e.g., an ARM™ microprocessor produced by Intel Corporation of Santa Clara, Calif.), non-volatile memory (e.g., read-only memory 152), and volatile memory (e.g., random access memory 154); each of which may be interconnected via one or more data/system buses 156, 158. Personal media device 12, 38 may also include an audio subsystem 160 for providing e.g., an analog audio signal to an audio jack 162 for removable engaging e.g., a headphone assembly 164, a remote speaker assembly 166, or an ear bud assembly 168, for example. Alternatively, personal media device 12, 38 may be configured to include one or more internal audio speakers (not shown).

Personal media device 12, 38 may execute a device application 64 (examples of which may include but are not limited to Rhapsody™ client, RealPlayer™ client, or a specialized interface). Personal media device 12, 38 may run an operating system, examples of which may include but are not limited to Microsoft Windows CE™, Redhat Linux™, Palm OS™, or a device-specific (i.e., custom) operating system.

The instruction sets and subroutines of device application 64, which may be stored on a storage device 66 coupled to personal media device 12, 38, may be executed by one or more processors (not shown) and one or more memory architectures (not shown) incorporated into personal media device 12, 38. Storage device 66 may be, for example, a hard disk drive, an optical drive, a random access memory (RAM), a read-only memory (ROM), a CF (i.e., compact flash) card, an SD (i.e., secure digital) card, a SmartMedia card, a Memory Stick, and a MultiMedia card, for example.

Personal media device 12, 38 may also include a user interface 170 and a display subsystem 172. User interface 170 may receive data signals from various input devices included within personal media device 12, 38, examples of which may include (but are not limited to): rating switches 74, 76; backward skip switch 78; forward skip switch 80; play/pause switch 82; menu switch 84; radio switch 86; and slider assembly 88, for example. Display subsystem 172 may provide display signals to display panel 90 included within personal media device 12, 38. Display panel 90 may be an active matrix liquid crystal display panel, a passive matrix liquid crystal display panel, or a light emitting diode display panel, for example.

Audio subsystem 160, user interface 170, and display subsystem 172 may each be coupled with microprocessor 150 via one or more data/system buses 174, 176, 178 (respectively).

During use of personal media device 12, 38, display panel 90 may be configured to display e.g., the title and artist of various pieces of media content 92, 94, 96 stored within personal media device 12, 38. Slider assembly 88 may be used to scroll upward or downward through the list of media content stored within personal media device 12, 38. When the desired piece of media content is highlighted (e.g., “Phantom Blues” by “Taj Mahal”), user 14 may select the media content for rendering using play/pause switch 82. User 14 may skip forward to the next piece of media content (e.g., “Happy To Be Just . . . ” by “Robert Johnson”) using forward skip switch 80; or skip backward to the previous piece of media content (e.g., “Big New Orleans . . . ” by “Leroy Brownstone”) using backward skip switch 78. Additionally, user 14 may rate the media content as they listen to it by using rating switches 74, 76.

The user may use display panel 90 in conjunction with e.g., slider assembly 88 to search/browse the media content stored within personal media device 12, 38. For example, to render search screen 100, the user may depress and hold slider assembly 88. Search screen 100 may include an artist field 102, an album field 104, and a track field 106. Using e.g., slider assembly 88, the user may navigate fields 100, 102, 104 and enter the appropriate search terms into the appropriate field. For example, the user may enter the phrase “Robert Johnson” into artist field 102. When populating field 102, slider assembly 88 may be used to enter the appropriate characters. For example, an upward or a downward movement of slider assembly 88 may allow the user to move between the fields and a depression of slider assembly 88 may result in a particular field being selected. Once selected, an upward or a downward movement of slider assembly 88 may enable the user to select the appropriate character and a depression of slider assembly 88 may result in the character being selected. Alternatively, personal media device 12, 38 may be configured to include a full or a partial keyboard (not shown). Once the search terms are defined, the user may select “search” button 108 or (alternatively) “cancel” button 110.

As discussed above, personal media device 12, 38 may include a bus interface 180 for interfacing with e.g., proxy computer 58 via docking cradle 60. Additionally and as discussed above, personal media device 12, 38 may be wirelessly coupled to network 30 (and/or other personal media devices) via e.g., a wireless communication channel 50 established between personal media device 12, 38 and e.g., WAP 52. Accordingly, personal media device 12, 38 may include a wireless interface 182 for wirelessly-coupling personal media device 12, 38 to network 30 (or network 32) and/or other personal media devices. Wireless interface 182 may be coupled to an antenna assembly 184 for RF communication to e.g., WAP 52, and/or an IR (i.e., infrared) communication assembly 186 for infrared communication with e.g., a second personal media device. Further and as discussed above, personal media device 12, 38 may include a storage device 66 for storing the instruction sets and subroutines of device application 64. Additionally, storage device 66 may be used to store media data files downloaded from media distribution system 18 and to temporarily store media data streams (or portions thereof) streamed from media distribution system 18.

Storage device 66, bus interface 180, and wireless interface 182 may each be coupled with microprocessor 150 via one or more data/system buses 188, 190, 192 (respectively).

As discussed above, media distribution system 18 may distribute media content to users 14, 20, 22, 24, 26, such that the media content distributed may be in the form of media data streams and/or media data files.

Accordingly, media distribution system 18 may be configured to only allow users to download media data files. For example, user 20 may be allowed to download, from media distribution system 18, media data files (i.e., examples of which may include but are not limited to audio files encoded and compressed using an MP3 encoder or an Advanced Audio Coding (AAC) encoder, or digital video encoded files), such that copies of the media data file are transferred to personal media device 38.

Alternatively, media distribution system 18 may be configured to only allow users to receive and process media data streams of media data files. For example, user 24 may be allowed to receive and process (on personal digital assistant 40) media data streams received from media distribution system 18. As discussed above, when media content is streamed from e.g., computer 28 to personal digital assistant 40, a copy of the media data file is not permanently retained on personal digital assistant 40.

Further, media distribution system 18 may be configured to allow users to receive and process media data streams and download media data files. Examples of such a media distribution system include the Rhapsody™ service offered by RealNetworks, Inc. of Seattle, Wash. Accordingly, user 26 may be allowed to download digital encoded media data files and receive and process media data streams from media distribution system 18. Therefore, copies of media data files may be transferred from computer 28 to cellular telephone 42; and streams of media data files may be received from computer 28 to cellular telephone 42.

Direct Access:

As discussed above, media distribution system 18 may be accessed directly or may be accessed through a proxy computer. For example, users 20, 24, 26 may directly access media distribution system 18 through various client electronic devices, examples of which may include, but are not limited to: personal media device 38; personal digital assistant 40; cellular telephone 42; televisions (not shown); cable boxes (not shown); internet radios (not shown); or dedicated network devices (not shown); for example.

When directly accessing media distribution system 18, a standardized protocol may be used. For example, SOAP (i.e., Simple Object Access Protocol) may be used to couple a client electronic device (e.g., personal media device 38; personal digital assistant 40; cellular telephone 42) to media distribution system 18.

As is known in the art, the SOAP protocol allows XML (eXtensible Markup Language) messages to be exchanged across computer networks (e.g., networks 30, 32). These message may be exchanged using HTTP (i.e., HyperText Transfer Protocol).

SOAP may use the RPC (i.e., Remote Procedure Protocol) process, in which a first network node (e.g. personal media device 38) sends a request message to another network node (e.g., computer 28), and the second network node (e.g., computer 28) sends a response message to the first network node (e.g., personal media device 38). While the system is described above as utilizing SOAP, other configurations are possible and are considered to be within the scope of this disclosure. For example, other protocols may be used, such a JSON (i.e., Java Script Object Notation), REST (i.e., REpresentational State Transfer), and XML-RPC (i.e., eXtensible Markup Language Remote Procedure Protocol).

Application Programming Interface:

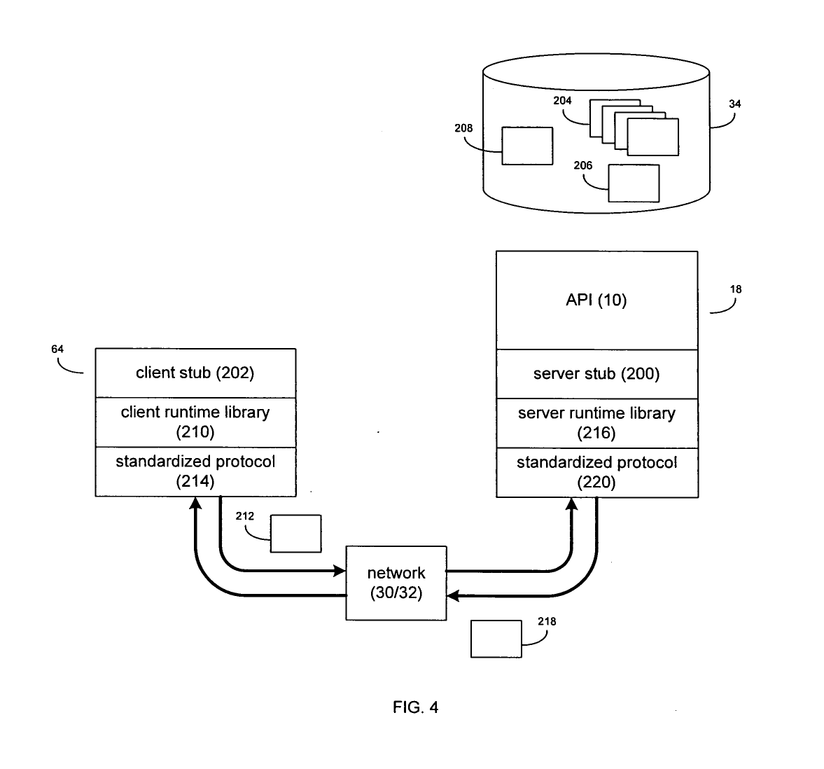

Referring also to FIGS. 4 & 5 and as discussed above, media distribution system 18 may include API 10 to enable communication between computer 28 and personal media device 38, personal digital assistant 40, and cellular telephone 42. via e.g., SOAP. Additionally and as will be discussed below in greater detail, media distribution system 18/API 10 may include one or more server stubs 200 to interact with one or more client stubs 202 included within device application 64.

API 10 may act as an interface for media distribution system 18 that allows requests for services to be made of media distribution system 18 by other computer programs (e.g., device application 64) and/or allows data to be retrieved from and/or provided to media distribution system 18.

API 10 may describe how device application 64 may access a set of functions (within media distribution system 18) without granting access to the source code of the functions (within media distribution system 18 ) or requiring a detailed understanding of the internal workings of the functions (within media distribution system 18).

As discussed above, media distribution system 18 provides media data files (in the form of downloads or streams) 204 to e.g., client electronic devices, such as: personal media device 12, 38; personal digital assistant 40; and cellular telephone 42. Media distribution system 18 may also maintain file catalog 206 that indexes media data files 204 and allows users to search/browse the media data files 204 available through media distribution system 18. File catalog 206 may be maintained on storage device 34 coupled to computer 28.

As will be discussed below in greater detail, API 10 may be configured to enable a user of a client electronic device (e.g., personal media devices 12, 38, personal digital assistant 40, and cellular telephone 42) to browse/search 250 file catalog 206 and identify 252 one or more media data files chosen from the plurality of media data files 204. Further, API 10 may be configured to receive 254 a data request, using a standardized protocol, from a client electronic device (e.g., personal media device 12, 38, personal digital assistant 40, and cellular telephone 42) and provide 256 data, in response to the received data request, to the client electronic device (e.g., personal media device 12, 38, personal digital assistant 40, and cellular telephone 42) in a third party usable format.

Configuring the Client Electronic Devices:

When configuring a client electronic device (e.g., personal media device 12, 38, personal digital assistant 40, and cellular telephone 42) to directly access media distribution system 18, a standardized protocol may be established between the two devices (e.g., the client electronic device and computer 28). As discussed above, an example of such a standardized protocol is SOAP. Once the standardized protocol is established and the devices are capable of communicating with each other, one or more WSDLs (i.e., Web Services Description Language) 208 resident on e.g., storage device 34 may be processed by the client electronic device to automate the generation of any required client stubs (e.g., client stub 202).

WSDL is a service description (typical XML) describing how a client device may communicate with a web service. For example, WSDL 208 may describe how device application 64 (and, therefore, a client electronic device) may communicate with media distribution system 18/API 10. For example, WSDL 208 may define e.g., the protocol bindings and message formats required to interact with media distribution system 18. Typically, the supported operations and messages are described abstractly, and then bound to the network protocol (e.g., SOAP). Accordingly, WSDL 208 may define the public interface for media distribution system 18.

Accordingly, when configuring a client electronic device to directly access media distribution system 18, once communication is established (using a standardized protocol) between computer 28 (i.e., the computer that executes media distribution system 18) and a client electronic device (e.g., personal media device 12, 38, personal digital assistant 40, and cellular telephone 42), the client electronic device may obtain one or more WSDLs 208 (from computer 28) and process them to generate the appropriate client stubs (e.g., client stub 202) for the services/functions that the client electronic device wishes to access. Examples of WSDLs 208 are as follows:

### WSDL Example #1

```
<?xml version=“1.0” encoding=“UTF-8”?>
<wsdl:definitions  xmlns=“http://schemas.xmlsoap.org/wsdl/”
xmlns:apachesoap=“http://xml.apache.org/xml-soap” xmlns:impl=“urn:rhapsodydirectsearch”
xmlns:intf=“urn:rhapsodydirectsearch” xmlns:soapenc=“http://schemas.xmlsoap.org/soap/encoding/”
xmlns:tns1=“http://kani.common.real.com” xmlns:wsdl=“http://schemas.xmlsoap.org/wsdl/”
xmlns:wsdlsoap=“http://schemas.xmlsoap.org/wsdl/soap/”
xmlns:xsd=“http://www.w3.org/2001/XMLSchema” targetNamespace=“urn:rhapsodydirectsearch”>
  <wsdl:types>
    <schema  targetNamespace=“urn:rhapsodydirectsearch”
xmlns=“http://www.w3.org/2001/XMLSchema”>
      <import namespace=“http://kani.common.real.com”/>
      <import namespace=“http://schemas.xmlsoap.org/soap/encoding/”/>
      <complexType name=“ArrayOf_xsd_string”>
        <complexContent>
          <restriction base=“soapenc:Array”>
            <attribute ref=“soapenc:arrayType” wsdl:arrayType=“xsd:string[ ]”/>
          </restriction>
        </complexContent>
      </complexType>
      <complexType name=“ArrayOf_tns1_LiteAlbumMetadata”>
        <complexContent>
          <restriction base=“soapenc:Array”>
            <attribute  ref=“soapenc:arrayType”
wsdl:arrayType=“tns1:LiteAlbumMetadata[ ]”/>
          </restriction>
        </complexContent>
      </complexType>
      <complexType name=“ArrayOf_tns1_LiteArtistMetadata”>
        <complexContent>
          <restriction base=“soapenc:Array”>
            <attribute  ref=“soapenc:arrayType”
wsdl:arrayType=“tns1:LiteArtistMetadata[ ]”/>
          </restriction>
        </complexContent>
      </complexType>
      <complexType name=“ArrayOf_tns1_LiteTrackMetadata”>
        <complexContent>
          <restriction base=“soapenc:Array”>
            <attribute  ref=“soapenc:arrayType”
wsdl:arrayType=“tns1:LiteTrackMetadata[ ]”/>
          </restriction>
        </complexContent>
      </complexType>
    </schema>
    <schema  targetNamespace=“http://kani.common.real.com”
xmlns=“http://www.w3.org/2001/XMLSchema”>
      <import namespace=“urn:rhapsodydirectsearch”/>
      <import namespace=“http://schemas.xmlsoap.org/soap/encoding/”/>
      <complexType name=“Money”>
        <sequence>
          <element name=“amount” nillable=“true” type=“xsd:string”/>
          <element name=“currencyCode” nillable=“true” type=“xsd:string”/>
        </sequence>
      </complexType>
      <complexType name=“LiteAlbumMetadata”>
        <sequence>
          <element name=“albumArt162x162Url” nillable=“true” type=“xsd:string”/>
          <element name=“albumId” nillable=“true” type=“xsd:string”/>
          <element name=“compilation” nillable=“true” type=“xsd:boolean”/>
          <element name=“displayName” nillable=“true” type=“xsd:string”/>
          <element  name=“displayableAlbumTypes” nillable=“true”
type=“impl:ArrayOf_xsd_string”/>
          <element name=“name” nillable=“true” type=“xsd:string”/>
          <element name=“parentalAuthority” nillable=“true” type=“xsd:boolean”/>
          <element name=“price” nillable=“true” type=“tns1:Money”/>
          <element  name=“primaryArtistDisplayName” nillable=“true”
type=“xsd:string”/>
          <element name=“primaryArtistId” nillable=“true” type=“xsd:string”/>
          <element name=“primaryStyle” nillable=“true” type=“xsd:string”/>
          <element name=“releaseYear” nillable=“true” type=“xsd:int”/>
          <element name=“rightFlags” nillable=“true” type=“xsd:long”/>
        </sequence>
      </complexType>
      <complexType name=“LiteArtistMetadata”>
        <sequence>
          <element name=“artistId” nillable=“true” type=“xsd:string”/>
          <element name=“name” nillable=“true” type=“xsd:string”/>
          <element name=“rightFlags” nillable=“true” type=“xsd:long”/>
        </sequence>
      </complexType>
      <complexType name=“LiteTrackMetadata”>
        <sequence>
          <element name=“albumId” nillable=“true” type=“xsd:string”/>
          <element name=“artistId” nillable=“true” type=“xsd:string”/>
          <element name=“blurbs” nillable=“true” type=“impl:ArrayOf_xsd_string”/>
          <element name=“discIndex” nillable=“true” type=“xsd:int”/>
          <element name=“displayAlbumName” nillable=“true” type=“xsd:string”/>
          <element name=“displayArtistName” nillable=“true” type=“xsd:string”/>
          <element name=“displayComposerName” nillable=“true” type=“xsd:string”/>
          <element name=“displayConductorName” nillable=“true” type=“xsd:string”/>
          <element name=“displayEnsembleName” nillable=“true” type=“xsd:string”/>
          <element name=“displayPerformerName” nillable=“true” type=“xsd:string”/>
          <element name=“genreId” nillable=“true” type=“xsd:string”/>
          <element name=“name” nillable=“true” type=“xsd:string”/>
          <element name=“playbackSeconds” nillable=“true” type=“xsd:int”/>
          <element name=“price” nillable=“true” type=“tns1:Money”/>
          <element name=“rightFlags” nillable=“true” type=“xsd:long”/>
          <element name=“trackId” nillable=“true” type=“xsd:string”/>
          <element name=“trackIndex” nillable=“true” type=“xsd:int”/>
        </sequence>
      </complexType>
    </schema>
  </wsdl:types>
  <wsdl:message name=“searchTracksByKeywordsRequest”>
    <wsdl:part name=“keywords” type=“impl:ArrayOf_xsd_string”/>
    <wsdl:part name=“cobrandId” type=“xsd:string”/>
  </wsdl:message>
  <wsdl:message name=“searchComposersByNameRequest”>
    <wsdl:part name=“composerName” type=“impl:ArrayOf_xsd_string”/>
    <wsdl:part name=“cobrandId” type=“xsd:string”/>
  </wsdl:message>
  <wsdl:message name=“searchArtistsByNameRequest”>
    <wsdl:part name=“names” type=“impl:ArrayOf_xsd_string”/>
    <wsdl:part name=“cobrandId” type=“xsd:string”/>
  </wsdl:message>
  <wsdl:message name=“searchComposersByNameResponse”>
    <wsdl:part name=“searchComposersByNameReturn”
type=“impl:ArrayOf_tns1_LiteArtistMetadata”/>
  </wsdl:message>
  <wsdl:message  name=“searchArtistsByNameResponse”>
    <wsdl:part name=“searchArtistsByNameReturn” type=“impl:ArrayOf_tns1_LiteArtistMetadata”/>
  </wsdl:message>
  <wsdl:message name=“searchTracksByKeywordsResponse”>
    <wsdl:part  name=“searchTracksByKeywordsReturn”
type=“impl:ArrayOf_tns1_LiteTrackMetadata”/>
  </wsdl:message>
  <wsdl:message name=“searchArtistsByNameStartingWithRequest”>
    <wsdl:part name=“prefix” type=“xsd:string”/>
    <wsdl:part name=“maxResults” type=“xsd:int”/>
    <wsdl:part name=“cobrandId” type=“xsd:string”/>
  </wsdl:message>
  <wsdl:message name=“searchTracksByNameResponse”>
    <wsdl:part name=“searchTracksByNameReturn” type=“impl:ArrayOf_tns1_LiteTrackMetadata”/>
  </wsdl:message>
  <wsdl:message name=“searchTracksByNameRequest”>
    <wsdl:part name=“names” type=“impl:ArrayOf_xsd_string”/>
    <wsdl:part name=“cobrandId” type=“xsd:string”/>
  </wsdl:message>
  <wsdl:message name=“searchAlbumsByNameRequest”>
    <wsdl:part name=“names” type=“impl:ArrayOf_xsd_string”/>
    <wsdl:part name=“cobrandId” type=“xsd:string”/>
  </wsdl:message>
  <wsdl:message name=“searchAlbumsByNameResponse”>
    <wsdl:part  name=“searchAlbumsByNameReturn”
type=“impl:ArrayOf_tns1_LiteAlbumMetadata”/>
  </wsdl:message>
  <wsdl:message name=“searchArtistsByNameStartingWithResponse”>
    <wsdl:part  name=“searchArtistsByNameStartingWithReturn”
type=“impl:ArrayOf_tns1_LiteArtistMetadata”/>
  </wsdl:message>
  <wsdl:portType name=“RhapsodyDirectSearchAxisAdapter”>
    <wsdl:operation name=“searchAlbumsByName” parameterOrder=“names cobrandId”>
      <wsdl:input  name=“searchAlbumsByNameRequest”
message=“impl:searchAlbumsByNameRequest”/>
      <wsdl:output  name=“searchAlbumsByNameResponse”
message=“impl:searchAlbumsByNameResponse”/>
    </wsdl:operation>
    <wsdl:operation name=“searchArtistsByName” parameterOrder=“names cobrandId”>
      <wsdl:input  name=“searchArtistsByNameRequest”
message=“impl:searchArtistsByNameRequest”/>
      <wsdl:output  name=“searchArtistsByNameResponse”
message=“impl:searchArtistsByNameResponse”/>
      </wsdl:operation>
      <wsdl:operation name=“searchArtistsByNameStartingWith” parameterOrder=“prefix maxResults
cobrandId”>
        <wsdl:input  name=“searchArtistsByNameStartingWithRequest”
message=“impl:searchArtistsByNameStartingWithRequest”/>
        <wsdl:output  name=“searchArtistsByNameStartingWithResponse”
message=“impl:searchArtistsByNameStartingWithResponse”/>
      </wsdl:operation>
      <wsdl:operation  name=“searchComposersByName” parameterOrder=“composerName
cobrandId”>
      <wsdl:input  name=“searchComposersByNameRequest”
message=“impl:searchComposersByNameRequest”/>
      <wsdl:output  name=“searchComposersByNameResponse”
message=“impl:searchComposersByNameResponse”/>
    </wsdl:operation>
    <wsdl:operation name=“searchTracksByKeywords” parameterOrder=“keywords cobrandId”>
      <wsdl:input  name=“searchTracksByKeywordsRequest”
message=“impl:searchTracksByKeywordsRequest”/>
      <wsdl:output  name=“searchTracksByKeywordsResponse”
message=“impl:searchTracksByKeywordsResponse”/>
    </wsdl:operation>
    <wsdl:operation name=“searchTracksByName” parameterOrder=“names cobrandId”>
      <wsdl:input  name=“searchTracksByNameRequest”
message=“impl:searchTracksByNameRequest”/>
      <wsdl:output  name=“searchTracksByNameResponse”
message=“impl:searchTracksByNameResponse”/>
    </wsdl:operation>
  </wsdl:portType>
  <wsdl:binding  name=“RhapsodyDirectSearchSoapBinding”
type=“impl:RhapsodyDirectSearchAxisAdapter”>
    <wsdlsoap:binding style=“rpc” transport=“http://schemas.xmlsoap.org/soap/http”/>
    <wsdl:operation name=“searchAlbumsByName”>
    <wsdlsoap:operation/>
    <wsdl:input>
      <wsdlsoap:body  use=“encoded”
encodingStyle=“http://schemas.xmlsoap.org/soap/encoding/” namespace=“urn:rhapsodydirectsearch”/>
    </wsdl:input>
    <wsdl:output>
      <wsdlsoap:body  use=“encoded”
encodingStyle=“http://schemas.xmlsoap.org/soap/encoding/” namespace=“urn:rhapsodydirectsearch”/>
    </wsdl:output>
  </wsdl:operation>
  <wsdl:operation name=“searchArtistsByName”>
    <wsdlsoap:operation/>
    <wsdl:input>
      <wsdlsoap:body  use=“encoded”
encodingStyle=“http://schemas.xmlsoap.org/soap/encoding/” namespace=“urn:rhapsodydirectsearch”/>
    </wsdl:input>
    <wsdl:output>
      <wsdlsoap:body  use=“encoded”
encodingStyle=“http://schemas.xmlsoap.org/soap/encoding/” namespace=“urn:rhapsodydirectsearch”/>
    </wsdl:output>
  </wsdl:operation>
  <wsdl:operation name=“searchArtistsByNameStartingWith”>
    <wsdlsoap:operation/>
    <wsdl:input>
      <wsdlsoap:body  use=“encoded”
encodingStyle=“http://schemas.xmlsoap.org/soap/encoding/” namespace=“urn:rhapsodydirectsearch”/>
    </wsdl:input>
    <wsdl:output>
      <wsdlsoap:body  use=“encoded”
encodingStyle=“http://schemas.xmlsoap.org/soap/encoding/” namespace=“urn:rhapsodydirectsearch”/>
    </wsdl:output>
  </wsdl:operation>
  <wsdl:operation name=“searchComposersByName”>
    <wsdlsoap:operation/>
    <wsdl:input>
      <wsdlsoap:body  use=“encoded”
encodingStyle=“http://schemas.xmlsoap.org/soap/encoding/” namespace=“urn:rhapsodydirectsearch”/>
    </wsdl:input>
    <wsdl:output>
      <wsdlsoap:body  use=“encoded”
encodingStyle=“http://schemas.xmlsoap.org/soap/encoding/” namespace=“urn:rhapsodydirectsearch”/>
    </wsdl:output>
  </wsdl:operation>
  <wsdl:operation name=“searchTracksByKeywords”>
    <wsdlsoap:operation/>
    <wsdl:input>
      <wsdlsoap:body  use=“encoded”
encodingStyle=“http://schemas.xmlsoap.org/soap/encoding/” namespace=“urn:rhapsodydirectsearch”/>
    </wsdl:input>
    <wsdl:output>
      <wsdlsoap:body  use=“encoded”
encodingStyle=“http://schemas.xmlsoap.org/soap/encoding/” namespace=“urn:rhapsodydirectsearch”/>
    </wsdl:output>
  </wsdl:operation>
  <wsdl:operation name=“searchTracksByName”>
    <wsdlsoap:operation/>
    <wsdl:input>
      <wsdlsoap:body  use=“encoded”
encodingStyle=“http://schemas.xmlsoap.org/soap/encoding/” namespace=“urn:rhapsodydirectsearch”/>
    </wsdl:input>
    <wsdl:output>
      <wsdlsoap:body  use=“encoded”
encodingStyle=“http://schemas.xmlsoap.org/soap/encoding/” namespace=“urn:rhapsodydirectsearch”/>
    </wsdl:output>
      </wsdl:operation>
    </wsdl:binding>
    <wsdl:service name=“RhapsodyDirectSearchAxisAdapterService”>
      <wsdl:port name=“RhapsodyDirectSearch” binding=“impl:RhapsodyDirectSearchSoapBinding”>
        <wsdlsoap:address
location=“http://direct.rhapsody.com/search/services/RhapsodyDirectSearch”/>
      </wsdl:port>
    </wsdl:service>
    <!--WSDL created by Apache Axis version: 1.4
Built on Apr 22, 2006 (06:55:48 PDT)-->
</wsdl:definitions>
```

### WSDL Example #2

```
<?xml version=“1.0” encoding=“UTF-8”?>
<wsdl:definitions  targetNamespace=“urn:rhapsodydirectaccountmgmt”
xmlns:apachesoap=“http://xml.apache.org/xml-soap” xmlns:impl=“urn:rhapsodydirectaccountmgmt”
xmlns:intf=“urn:rhapsodydirectaccountmgmt”
xmlns:soapenc=“http://schemas.xmlsoap.org/soap/encoding/” xmlns:tns1=“http://kani.common.real.com”
xmlns:wsdl=“http://schemas.xmlsoap.org/wsdl/” xmlns:wsdlsoap=“http://schemas.xmlsoap.org/wsdl/soap/”
xmlns:xsd=“http://www.w3.org/2001/XMLSchema”>
<!--WSDL created by Apache Axis version: 1.4
Built on Apr 22, 2006 (06:55:48 PDT)-->
<wsdl:types>
  <schema  targetNamespace=“http://kani.common.real.com”
xmlns=“http://www.w3.org/2001/XMLSchema”>
  <import namespace=“urn:rhapsodydirectaccountmgmt”/>
  <import namespace=“http://schemas.xmlsoap.org/soap/encoding/”/>
  <complexType name=“MemberCredentials”>
    <sequence>
      <element name=“cobrand” nillable=“true” type=“xsd:string”/>
      <element name=“logon” nillable=“true” type=“xsd:string”/>
      <element name=“password” nillable=“true” type=“xsd:string”/>
    </sequence>
  </complexType>
  <complexType name=“UpgradeMemberAccountResult”>
    <sequence>
    <element name=“upgradeResult” type=“xsd:boolean”/>
      </sequence>
    </complexType>
  <complexType name=“CobrandMetaData”>
    <sequence>
      <element name=“cobrandId” nillable=“true” type=“xsd:string”/>
      <element name=“name” nillable=“true” type=“xsd:string”/>
    </sequence>
  </complexType>
  <complexType name=“AccountMetaData”>
    <sequence>
      <element name=“accountType” nillable=“true” type=“xsd:string”/>
      <element name=“cobrand” nillable=“true” type=“xsd:string”/>
      <element name=“country” nillable=“true” type=“xsd:string”/>
      <element name=“dateCreated” nillable=“true” type=“xsd:dateTime”/>
      <element name=“email” nillable=“true” type=“xsd:string”/>
      <element name=“firstName” nillable=“true” type=“xsd:string”/>
      <element name=“freePlaysRemaining” type=“xsd:int”/>
      <element name=“freeTrialTimeLeftInMillis” type=“xsd:long”/>
      <element name=“lastName” nillable=“true” type=“xsd:string”/>
      <element name=“rhapsody25MonthReset” nillable=“true” type=“xsd:dateTime”/>
      <element name=“trialTerminationDate” nillable=“true” type=“xsd:dateTime”/>
      <element name=“userName” nillable=“true” type=“xsd:string”/>
      <element name=“zip” nillable=“true” type=“xsd:string”/>
    </sequence>
  </complexType>
  </schema>
  <schema  targetNamespace=“urn:rhapsodydirectaccountmgmt”
xmlns=“http://www.w3.org/2001/XMLSchema”>
  <import namespace=“http://kani.common.real.com”/>
  <import namespace=“http://schemas.xmlsoap.org/soap/encoding/”/>
  <complexType name=“ArrayOf_tns1_CobrandMetaData”>
      <complexContent>
        <restriction base=“soapenc:Array”>
          <attribute ref=“soapenc:arrayType” wsdl:arrayType=“tns1:CobrandMetaData[ ]”/>
        </restriction>
      </complexContent>
    </complexType>
  </schema>
</wsdl:types>
  <wsdl:message name=“getAllCobrandsResponse”>
    <wsdl:part name=“getAllCobrandsReturn” type=“impl:ArrayOf_tns1_CobrandMetaData”/>
  </wsdl:message>
  <wsdl:message name=“upgradeMemberAccountResponse”>
    <wsdl:part name=“upgradeMemberAccountReturn” type=“tns1:UpgradeMemberAccountResult”/>
  </wsdl:message>
  <wsdl:message name=“getMemberAccountRequest”>
    <wsdl:part name=“machineId” type=“xsd:string”/>
    <wsdl:part name=“cobrandId” type=“xsd:string”/>
    <wsdl:part name=“accountType” type=“xsd:string”/>
    <wsdl:part name=“domainName” type=“xsd:string”/>
    <wsdl:part name=“developerKey” type=“xsd:string”/>
  </wsdl:message>
  <wsdl:message name=“upgradeMemberAccountRequest”>
    <wsdl:part name=“logon” type=“xsd:string”/>
    <wsdl:part name=“cobrandId” type=“xsd:string”/>
    <wsdl:part name=“password” type=“xsd:string”/>
    <wsdl:part name=“newLogon” type=“xsd:string”/>
    <wsdl:part name=“newCobrandId” type=“xsd:string”/>
    <wsdl:part name=“newPassword” type=“xsd:string”/>
    <wsdl:part name=“accountType” type=“xsd:string”/>
    <wsdl:part name=“developerKey” type=“xsd:string”/>
  </wsdl:message>
  <wsdl:message name=“getAllCobrandsRequest”>
    <wsdl:part name=“developerKey” type=“xsd:string”/>
  </wsdl:message>
  <wsdl:message name=“getCobrandsResponse”>
    <wsdl:part name=“getCobrandsReturn” type=“impl:ArrayOf_tns1_CobrandMetaData”/>
  </wsdl:message>
  <wsdl:message name=“getVersionStringResponse”>
    <wsdl:part name=“getVersionStringReturn” type=“xsd:string”/>
  </wsdl:message>
  <wsdl:message name=“getAccountPropertiesResponse”>
    <wsdl:part name=“getAccountPropertiesReturn” type=“tns1:AccountMetaData”/>
  </wsdl:message>
  <wsdl:message name=“getAccountPropertiesRequest”>
    <wsdl:part name=“logon” type=“xsd:string”/>
    <wsdl:part name=“cobrandId” type=“xsd:string”/>
    <wsdl:part name=“password” type=“xsd:string”/>
    <wsdl:part name=“developerKey” type=“xsd:string”/>
  </wsdl:message>
  <wsdl:message name=“getMemberAccountResponse”>
    <wsdl:part name=“getMemberAccountReturn” type=“tns1:MemberCredentials”/>
  </wsdl:message>
  <wsdl:message name=“getCobrandsRequest”>
    <wsdl:part name=“logon” type=“xsd:string”/>
    <wsdl:part name=“password” type=“xsd:string”/>
    <wsdl:part name=“developerKey” type=“xsd:string”/>
  </wsdl:message>
  <wsdl:message name=“getVersionStringRequest”>
  </wsdl:message>
  <wsdl:portType name=“RhapsodyDirectAccountMgmtAxisAdapter”>
    <wsdl:operation name=“getVersionString”>
      <wsdl:input message=“impl:getVersionStringRequest” name=“getVersionStringRequest”/>
      <wsdl:output message=“impl:getVersionStringResponse” name=“getVersionStringResponse”/>
    </wsdl:operation>
    <wsdl:operation name=“getMemberAccount” parameterOrder=“machineId cobrandId accountType
domainName developerKey”>
      <wsdl:input message=“impl:getMemberAccountRequest” name=“getMemberAccountRequest”/>
      <wsdl:output message=“impl:getMemberAccountResponse” name=“getMemberAccountResponse”/>
    </wsdl:operation>
    <wsdl:operation  name=“upgradeMemberAccount” parameterOrder=“logon cobrandId password
newLogon newCobrandId newPassword accountType developerKey”>
      <wsdl:input  message=“impl:upgradeMemberAccountRequest”
name=“upgradeMemberAccountRequest”/>
      <wsdl:output  message=“impl:upgradeMemberAccountResponse”
name=“upgradeMemberAccountResponse”/>
    </wsdl:operation>
    <wsdl:operation name=“getAllCobrands” parameterOrder=“developerKey”>
      <wsdl:input message=“impl:getAllCobrandsRequest” name=“getAllCobrandsRequest”/>
      <wsdl:output message=“impl:getAllCobrandsResponse” name=“getAllCobrandsResponse”/>
    </wsdl:operation>
    <wsdl:operation name=“getCobrands” parameterOrder=“logon password developerKey”>
      <wsdl:input message=“impl:getCobrandsRequest” name=“getCobrandsRequest”/>
      <wsdl:output message=“impl:getCobrandsResponse” name=“getCobrandsResponse”/>
    </wsdl:operation>
    <wsdl:operation  name=“getAccountProperties” parameterOrder=“logon  cobrandId  password
developerKey”>
      <wsdl:input message=“impl:getAccountPropertiesRequest” name=“getAccountPropertiesRequest”/>
      <wsdl:output  message=“impl:getAccountPropertiesResponse”
name=“getAccountPropertiesResponse”/>
    </wsdl:operation>
  </wsdl:portType>
  <wsdl:binding  name=“RhapsodyDirectAccountMgmtSoapBinding”
type=“impl:RhapsodyDirectAccountMgmtAxisAdapter”>
    <wsdlsoap:binding style=“rpc” transport=“http://schemas.xmlsoap.org/soap/http”/>
    <wsdl:operation name=“getVersionString”>
      <wsdlsoap:operation soapAction=“”/>
      <wsdl:input name=“getVersionStringRequest”>
        <wsdlsoap:body  encodingStyle=“http://schemas.xmlsoap.org/soap/encoding/”
namespace=“urn:rhapsodydirectaccountmgmt” use=“encoded”/>
    </wsdl:input>
    <wsdl:output name=“getVersionStringResponse”>
      <wsdlsoap:body  encodingStyle=“http://schemas.xmlsoap.org/soap/encoding/”
namespace=“urn:rhapsodydirectaccountmgmt” use=“encoded”/>
    </wsdl:output>
  </wsdl:operation>
  <wsdl:operation name=“getMemberAccount”>
    <wsdlsoap:operation soapAction=“”/>
    <wsdl:input name=“getMemberAccountRequest”>
      <wsdlsoap:body  encodingStyle=“http://schemas.xmlsoap.org/soap/encoding/”
namespace=“urn:rhapsodydirectaccountmgmt” use=“encoded”/>
    </wsdl:input>
    <wsdl:output name=“getMemberAccountResponse”>
      <wsdlsoap:body  encodingStyle=“http://schemas.xmlsoap.org/soap/encoding/”
namespace=“urn:rhapsodydirectaccountmgmt” use=“encoded”/>
    </wsdl:output>
  </wsdl:operation>
  <wsdl:operation name=“upgradeMemberAccount”>
    <wsdlsoap:operation soapAction=“”/>
    <wsdl:input name=“upgradeMemberAccountRequest”>
      <wsdlsoap:body  encodingStyle=“http://schemas.xmlsoap.org/soap/encoding/”
namespace=“urn:rhapsodydirectaccountmgmt” use=“encoded”/>
    </wsdl:input>
    <wsdl:output name=“upgradeMemberAccountResponse”>
      <wsdlsoap:body  encodingStyle=“http://schemas.xmlsoap.org/soap/encoding/”
namespace=“urn:rhapsodydirectaccountmgmt” use=“encoded”/>
    </wsdl:output>
  </wsdl:operation>
  <wsdl:operation name=“getAllCobrands”>
    <wsdlsoap:operation soapAction=“”/>
    <wsdl:input name=“getAllCobrandsRequest”>
      <wsdlsoap:body  encodingStyle=“http://schemas.xmlsoap.org/soap/encoding/”
namespace=“urn:rhapsodydirectaccountmgmt” use=“encoded”/>
    </wsdl:input>
    <wsdl:output name=“getAllCobrandsResponse”>
      <wsdlsoap:body  encodingStyle=“http://schemas.xmlsoap.org/soap/encoding/”
namespace=“urn:rhapsodydirectaccountmgmt” use=“encoded”/>
    </wsdl:output>
  </wsdl:operation>
  <wsdl:operation name=“getCobrands”>
    <wsdlsoap:operation soapAction=“”/>
    <wsdl:input name=“getCobrandsRequest”>
      <wsdlsoap:body  encodingStyle=“http://schemas.xmlsoap.org/soap/encoding/”
namespace=“urn:rhapsodydirectaccountmgmt” use=“encoded”/>
    </wsdl:input>
    <wsdl:output name=“getCobrandsResponse”>
      <wsdlsoap:body  encodingStyle=“http://schemas.xmlsoap.org/soap/encoding/”
namespace=“urn:rhapsodydirectaccountmgmt” use=“encoded”/>
    </wsdl:output>
  </wsdl:operation>
  <wsdl:operation name=“getAccountProperties”>
    <wsdlsoap:operation soapAction=“”/>
    <wsdl:input name=“getAccountPropertiesRequest”>
      <wsdlsoap:body  encodingStyle=“http://schemas.xmlsoap.org/soap/encoding/”
namespace=“urn:rhapsodydirectaccountmgmt” use=“encoded”/>
    </wsdl:input>
    <wsdl:output name=“getAccountPropertiesResponse”>
      <wsdlsoap:body  encodingStyle=“http://schemas.xmlsoap.org/soap/encoding/”
namespace=“urn:rhapsodydirectaccountmgmt” use=“encoded”/>
      </wsdl:output>
    </wsdl:operation>
  </wsdl:binding>
  <wsdl:service name=“RhapsodyDirectAccountMgmtAxisAdapterService”>
    <wsdl:port  binding=“impl:RhapsodyDirectAccountMgmtSoapBinding”
name=“RhapsodyDirectAccountMgmt”>
      <wsdlsoap:address  location=“https://secure-
direct.rhapsody.com/account/services/RhapsodyDirectAccountMgmt”/>
    </wsdl:port>
  </wsdl:service>
</wsdl:definitions>
```

### WSDL Example #3

```
<?xml version=“1.0” encoding=“UTF-8”?>
<wsdl:definitions  targetNamespace=“urn:rhapsodydirectplayback”
xmlns:apachesoap=“http://xml.apache.org/xml-soap” xmlns:impl=“urn:rhapsodydirectplayback”
xmlns:intf=“urn:rhapsodydirectplayback” xmlns:soapenc=“http://schemas.xmlsoap.org/soap/encoding/”
xmlns:tns1=“http://kani.common.real.com” xmlns:wsdl=“http://schemas.xmlsoap.org/wsdl/”
xmlns:wsdlsoap=“http://schemas.xmlsoap.org/wsdl/soap/”
xmlns:xsd=“http://www.w3.org/2001/XMLSchema”>
<!--WSDL created by Apache Axis version: 1.4
Built on Apr 22, 2006 (06:55:48 PDT)-->
<wsdl:types>
  <schema  targetNamespace=“urn:rhapsodydirectplayback”
xmlns=“http://www.w3.org/2001/XMLSchema”>
    <import namespace=“http://kani.common.real.com”/>
    <import namespace=“http://schemas.xmlsoap.org/soap/encoding/”/>
    <complexType name=“ArrayOf_xsd_string”>
      <complexContent>
        <restriction base=“soapenc:Array”>
          <attribute ref=“soapenc:arrayType” wsdl:arrayType=“xsd:string[ ]”/>
        </restriction>
      </complexContent>
    </complexType>
    <complexType name=“Money”>
      <sequence>
        <element name=“amount” nillable=“true” type=“xsd:string”/>
        <element name=“currencyCode” nillable=“true” type=“xsd:string”/>
      </sequence>
    </complexType>
    <complexType name=“ArrayOf_tns1_TrackPlaybackInfo”>
      <complexContent>
        <restriction base=“soapenc:Array”>
          <attribute ref=“soapenc:arrayType” wsdl:arrayType=“tns1:TrackPlaybackInfo[ ]”/>
        </restriction>
      </complexContent>
    </complexType>
  </schema>
  <schema  targetNamespace=“http://kani.common.real.com”
xmlns=“http://www.w3.org/2001/XMLSchema”>
  <import namespace=“urn:rhapsodydirectplayback”/>
  <import namespace=“http://schemas.xmlsoap.org/soap/encoding/”/>
  <complexType name=“LiteTrackMetadata”>
    <sequence>
      <element name=“albumId” nillable=“true” type=“xsd:string”/>
      <element name=“artistId” nillable=“true” type=“xsd:string”/>
      <element name=“blurbs” nillable=“true” type=“impl:ArrayOf_xsd_string”/>
      <element name=“discIndex” nillable=“true” type=“xsd:int”/>
      <element name=“displayAlbumName” nillable=“true” type=“xsd:string”/>
      <element name=“displayArtistName” nillable=“true” type=“xsd:string”/>
      <element name=“displayComposerName” nillable=“true” type=“xsd:string”/>
      <element name=“displayConductorName” nillable=“true” type=“xsd:string”/>
      <element name=“displayEnsembleName” nillable=“true” type=“xsd:string”/>
      <element name=“displayPerformerName” nillable=“true” type=“xsd:string”/>
      <element name=“genreId” nillable=“true” type=“xsd:string”/>
      <element name=“name” nillable=“true” type=“xsd:string”/>
      <element name=“playbackSeconds” nillable=“true” type=“xsd:int”/>
      <element name=“price” nillable=“true” type=“impl:Money”/>
      <element name=“rightFlags” nillable=“true” type=“xsd:long”/>
      <element name=“trackId” nillable=“true” type=“xsd:string”/>
      <element name=“trackIndex” nillable=“true” type=“xsd:int”/>
    </sequence>
  </complexType>
  <complexType name=“TrackPlaybackFormat”>
    <sequence>
      <element name=“bitRate” nillable=“true” type=“xsd:int”/>
      <element name=“format” nillable=“true” type=“xsd:string”/>
      <element name=“radVersion” nillable=“true” type=“xsd:int”/>
    </sequence>
  </complexType>
  <complexType name=“TrackPlaybackInfo”>
    <sequence>
      <element name=“mediaUrl” nillable=“true” type=“xsd:string”/>
      <element name=“trackMetadata” nillable=“true” type=“tns1:LiteTrackMetadata”/>
      <element name=“trackPlaybackFormat” nillable=“true” type=“tns1:TrackPlaybackFormat”/>
    </sequence>
  </complexType>
  <complexType name=“LogMeteringResult”>
    <sequence>
      <element name=“logged” type=“xsd:boolean”/>
      </sequence>
    </complexType>
  </schema>
</wsdl:types>
  <wsdl:message name=“getTrackPlaybackInfosRequest”>
    <wsdl:part name=“trackId” type=“xsd:string”/>
    <wsdl:part name=“logon” type=“xsd:string”/>
    <wsdl:part name=“cobrandId” type=“xsd:string”/>
    <wsdl:part name=“playbackSessionId” type=“xsd:string”/>
  </wsdl:message>
  <wsdl:message name=“getTrackPlaybackInfosResponse”>
    <wsdl:part name=“getTrackPlaybackInfosReturn” type=“impl:ArrayOf_tns1_TrackPlaybackInfo”/>
  </wsdl:message>
  <wsdl:message name=“startPlaybackSessionResponse”>
    <wsdl:part name=“startPlaybackSessionReturn” type=“xsd:string”/>
  </wsdl:message>
  <wsdl:message name=“getEAResponse”>
    <wsdl:part name=“getEAReturn” type=“xsd:base64Binary”/>
  </wsdl:message>
  <wsdl:message name=“getTrackPlaybackInfoRequest”>
    <wsdl:part name=“trackId” type=“xsd:string”/>
    <wsdl:part name=“logon” type=“xsd:string”/>
    <wsdl:part name=“playbackSessionId” type=“xsd:string”/>
    <wsdl:part name=“cobrandId” type=“xsd:string”/>
    <wsdl:part name=“radversion” type=“xsd:int”/>
    <wsdl:part name=“format” type=“xsd:string”/>
    <wsdl:part name=“bitrate” type=“xsd:int”/>
  </wsdl:message>
  <wsdl:message name=“startPlaybackSessionRequest”>
    <wsdl:part name=“logon” type=“xsd:string”/>
    <wsdl:part name=“cobrandId” type=“xsd:string”/>
    <wsdl:part name=“password” type=“xsd:string”/>
    <wsdl:part name=“clientType” type=“xsd:string”/>
    <wsdl:part name=“developerKey” type=“xsd:string”/>
  </wsdl:message>
  <wsdl:message name=“logMeteringInfoForStationTrackPlayResponse”>
    <wsdl:part name=“logMeteringInfoForStationTrackPlayReturn” type=“tns1:LogMeteringResult”/>
  </wsdl:message>
  <wsdl:message name=“getVersionStringResponse”>
    <wsdl:part name=“getVersionStringReturn” type=“xsd:string”/>
  </wsdl:message>
  <wsdl:message name=“logMeteringInfoForStationTrackPlayRequest”>
    <wsdl:part name=“logon” type=“xsd:string”/>
    <wsdl:part name=“cobrandId” type=“xsd:string”/>
    <wsdl:part name=“stationId” type=“xsd:string”/>
    <wsdl:part name=“trackId” type=“xsd:string”/>
    <wsdl:part name=“actionId” type=“xsd:string”/>
    <wsdl:part name=“playtime” type=“xsd:int”/>
    <wsdl:part name=“format” type=“xsd:string”/>
    <wsdl:part name=“bitrate” type=“xsd:int”/>
    <wsdl:part name=“clientType” type=“xsd:string”/>
    <wsdl:part name=“developerKey” type=“xsd:string”/>
  </wsdl:message>
  <wsdl:message name=“logMeteringInfoResponse”>
    <wsdl:part name=“logMeteringInfoReturn” type=“tns1:LogMeteringResult”/>
  </wsdl:message>
  <wsdl:message name=“getTrackPlaybackInfoResponse”>
    <wsdl:part name=“getTrackPlaybackInfoReturn” type=“tns1:TrackPlaybackInfo”/>
  </wsdl:message>
  <wsdl:message name=“logMeteringInfoRequest”>
    <wsdl:part name=“logon” type=“xsd:string”/>
    <wsdl:part name=“cobrandId” type=“xsd:string”/>
    <wsdl:part name=“trackId” type=“xsd:string”/>
    <wsdl:part name=“actionId” type=“xsd:string”/>
    <wsdl:part name=“playtime” type=“xsd:int”/>
    <wsdl:part name=“format” type=“xsd:string”/>
    <wsdl:part name=“bitrate” type=“xsd:int”/>
    <wsdl:part name=“clientType” type=“xsd:string”/>
    <wsdl:part name=“developerKey” type=“xsd:string”/>
  </wsdl:message>
  <wsdl:message name=“endPlaybackSessionRequest”>
    <wsdl:part name=“logon” type=“xsd:string”/>
    <wsdl:part name=“clientType” type=“xsd:string”/>
    <wsdl:part name=“playbackSessionId” type=“xsd:string”/>
    <wsdl:part name=“developerKey” type=“xsd:string”/>
  </wsdl:message>
  <wsdl:message name=“getVersionStringRequest”>
  </wsdl:message>
  <wsdl:message name=“getEARequest”>
    <wsdl:part name=“trackId” type=“xsd:string”/>
    <wsdl:part name=“logon” type=“xsd:string”/>
    <wsdl:part name=“playbackSessionId” type=“xsd:string”/>
    <wsdl:part name=“cobrandId” type=“xsd:string”/>
    <wsdl:part name=“position” type=“xsd:int”/>
    <wsdl:part name=“count” type=“xsd:int”/>
    <wsdl:part name=“radversion” type=“xsd:int”/>
    <wsdl:part name=“format” type=“xsd:string”/>
    <wsdl:part name=“bitrate” type=“xsd:int”/>
  </wsdl:message>
  <wsdl:message name=“endPlaybackSessionResponse”>
    <wsdl:part name=“endPlaybackSessionReturn” type=“xsd:boolean”/>
  </wsdl:message>
  <wsdl:portType name=“RhapsodyDirectPlaybackAxisAdapter”>
    <wsdl:operation name=“getEA” parameterOrder=“trackId logon playbackSessionId cobrandId position
count radversion format bitrate”>
      <wsdl:input message=“impl:getEARequest” name=“getEARequest”/>
      <wsdl:output message=“impl:getEAResponse” name=“getEAResponse”/>
    </wsdl:operation>
    <wsdl:operation name=“getVersionString”>
      <wsdl:input message=“impl:getVersionStringRequest” name=“getVersionStringRequest”/>
      <wsdl:output message=“impl:getVersionStringResponse” name=“getVersionStringResponse”/>
    </wsdl:operation>
    <wsdl:operation name=“getTrackPlaybackInfo” parameterOrder=“trackId  logon  playbackSessionId
cobrandId radversion format bitrate”>
      <wsdl:input message=“impl:getTrackPlaybackInfoRequest” name=“getTrackPlaybackInfoRequest”/>
      <wsdl:output  message=“impl:getTrackPlaybackInfoResponse”
name=“getTrackPlaybackInfoResponse”/>
    </wsdl:operation>
    <wsdl:operation  name=“getTrackPlaybackInfos” parameterOrder=“trackId  logon  cobrandId
playbackSessionId”>
      <wsdl:input  message=“impl:getTrackPlaybackInfosRequest”
name=“getTrackPlaybackInfosRequest”/>
      <wsdl:output  message=“impl:getTrackPlaybackInfosResponse”
name=“getTrackPlaybackInfosResponse”/>
    </wsdl:operation>
    <wsdl:operation name=“startPlaybackSession” parameterOrder=“logon cobrandId password clientType
developerKey”>
      <wsdl:input message=“impl:startPlaybackSessionRequest” name=“startPlaybackSessionRequest”/>
      <wsdl:output  message=“impl:startPlaybackSessionResponse”
name=“startPlaybackSessionResponse”/>
    </wsdl:operation>
    <wsdl:operation name=“endPlaybackSession” parameterOrder=“logon clientType playbackSessionId
developerKey”>
      <wsdl:input message=“impl:endPlaybackSessionRequest” name=“endPlaybackSessionRequest”/>
      <wsdl:output  message=“impl:endPlaybackSessionResponse”
name=“endPlaybackSessionResponse”/>
    </wsdl:operation>
    <wsdl:operation name=“logMeteringInfo” parameterOrder=“logon cobrandId trackId actionId playtime
format bitrate clientType developerKey”>
      <wsdl:input message=“impl:logMeteringInfoRequest” name=“logMeteringInfoRequest”/>
      <wsdl:output message=“impl:logMeteringInfoResponse” name=“logMeteringInfoResponse”/>
    </wsdl:operation>
    <wsdl:operation  name=“logMeteringInfoForStationTrackPlay” parameterOrder=“logon  cobrandId
stationId trackId actionId playtime format bitrate clientType developerKey”>
      <wsdl:input  message=“impl:logMeteringInfoForStationTrackPlayRequest”
name=“logMeteringInfoForStationTrackPlayRequest”/>
      <wsdl:output  message=“impl:logMeteringInfoForStationTrackPlayResponse”
name=“logMeteringInfoForStationTrackPlayResponse”/>
    </wsdl:operation>
  </wsdl:portType>
  <wsdl:binding  name=“RhapsodyDirectPlaybackSoapBinding”
type=“impl:RhapsodyDirectPlaybackAxisAdapter”>
    <wsdlsoap:binding style=“rpc” transport=“http://schemas.xmlsoap.org/soap/http”/>
    <wsdl:operation name=“getEA”>
      <wsdlsoap:operation soapAction=“”/>
      <wsdl:input name=“getEARequest”>
        <wsdlsoap:body  encodingStyle=“http://schemas.xmlsoap.org/soap/encoding/”
namespace=“urn:rhapsodydirectplayback” use=“encoded”/>
      </wsdl:input>
      <wsdl:output name=“getEAResponse”>
        <wsdlsoap:body  encodingStyle=“http://schemas.xmlsoap.org/soap/encoding/”
namespace=“urn:rhapsodydirectplayback” use=“encoded”/>
      </wsdl:output>
    </wsdl:operation>
    <wsdl:operation name=“getVersionString”>
      <wsdlsoap:operation soapAction=“”/>
      <wsdl:input name=“getVersionStringRequest”>
        <wsdlsoap:body  encodingStyle=“http://schemas.xmlsoap.org/soap/encoding/”
namespace=“urn:rhapsodydirectplayback” use=“encoded”/>
      </wsdl:input>
      <wsdl:output name=“getVersionStringResponse”>
        <wsdlsoap:body  encodingStyle=“http://schemas.xmlsoap.org/soap/encoding/”
namespace=“urn:rhapsodydirectplayback” use=“encoded”/>
      </wsdl:output>
    </wsdl:operation>
    <wsdl:operation name=“getTrackPlaybackInfo”>
      <wsdlsoap:operation soapAction=“”/>
      <wsdl:input name=“getTrackPlaybackInfoRequest”>
        <wsdlsoap:body  encodingStyle=“http://schemas.xmlsoap.org/soap/encoding/”
namespace=“urn:rhapsodydirectplayback” use=“encoded”/>
      </wsdl:input>
      <wsdl:output name=“getTrackPlaybackInfoResponse”>
        <wsdlsoap:body  encodingStyle=“http://schemas.xmlsoap.org/soap/encoding/”
namespace=“urn:rhapsodydirectplayback” use=“encoded”/>
      </wsdl:output>
    </wsdl:operation>
    <wsdl:operation name=“getTrackPlaybackInfos”>
      <wsdlsoap:operation soapAction=“”/>
      <wsdl:input name=“getTrackPlaybackInfosRequest”>
        <wsdlsoap:body  encodingStyle=“http://schemas.xmlsoap.org/soap/encoding/”
namespace=“urn:rhapsodydirectplayback” use=“encoded”/>
      </wsdl:input>
      <wsdl:output name=“getTrackPlaybackInfosResponse”>
        <wsdlsoap:body  encodingStyle=“http://schemas.xmlsoap.org/soap/encoding/”
namespace=“urn:rhapsodydirectplayback” use=“encoded”/>
      </wsdl:output>
    </wsdl:operation>
    <wsdl:operation name=“startPlaybackSession”>
      <wsdlsoap:operation soapAction=“”/>
      <wsdl:input name=“startPlaybackSessionRequest”>
        <wsdlsoap:body  encodingStyle=“http://schemas.xmlsoap.org/soap/encoding/”
namespace=“urn:rhapsodydirectplayback” use=“encoded”/>
      </wsdl:input>
      <wsdl:output name=“startPlaybackSessionResponse”>
        <wsdlsoap:body  encodingStyle=“http://schemas.xmlsoap.org/soap/encoding/”
namespace=“urn:rhapsodydirectplayback” use=“encoded”/>
      </wsdl:output>
    </wsdl:operation>
    <wsdl:operation name=“endPlaybackSession”>
      <wsdlsoap:operation soapAction=“”/>
      <wsdl:input name=“endPlaybackSessionRequest”>
        <wsdlsoap:body  encodingStyle=“http://schemas.xmlsoap.org/soap/encoding/”
namespace=“urn:rhapsodydirectplayback” use=“encoded”/>
      </wsdl:input>
      <wsdl:output name=“endPlaybackSessionResponse”>
        <wsdlsoap:body  encodingStyle=“http://schemas.xmlsoap.org/soap/encoding/”
namespace=“urn:rhapsodydirectplayback” use=“encoded”/>
      </wsdl:output>
    </wsdl:operation>
    <wsdl:operation name=“logMeteringInfo”>
      <wsdlsoap:operation soapAction=“”/>
      <wsdl:input name=“logMeteringInfoRequest”>
        <wsdlsoap:body  encodingStyle=“http://schemas.xmlsoap.org/soap/encoding/”
namespace=“urn:rhapsodydirectplayback” use=“encoded”/>
      </wsdl:input>
      <wsdl:output name=“logMeteringInfoResponse”>
        <wsdlsoap:body  encodingStyle=“http://schemas.xmlsoap.org/soap/encoding/”
namespace=“urn:rhapsodydirectplayback” use=“encoded”/>
      </wsdl:output>
    </wsdl:operation>
    <wsdl:operation name=“logMeteringInfoForStationTrackPlay”>
      <wsdlsoap:operation soapAction=“”/>
      <wsdl:input name=“logMeteringInfoForStationTrackPlayRequest”>
        <wsdlsoap:body  encodingStyle=“http://schemas.xmlsoap.org/soap/encoding/”
namespace=“urn:rhapsodydirectplayback” use=“encoded”/>
      </wsdl:input>
      <wsdl:output name=“logMeteringInfoForStationTrackPlayResponse”>
        <wsdlsoap:body  encodingStyle=“http://schemas.xmlsoap.org/soap/encoding/”
namespace=“urn:rhapsodydirectplayback” use=“encoded”/>
      </wsdl:output>
    </wsdl:operation>
    </wsdl:binding>
      <wsdl:service name=“RhapsodyDirectPlaybackAxisAdapterService”>
      <wsdl:port binding=“impl:RhapsodyDirectPlaybackSoapBinding” name=“RhapsodyDirectPlayback”>
        <wsdlsoap:address  location=“https://secure-
direct.rhapsody.com/playback/services/RhapsodyDirectPlayback”/>
    </wsdl:port>
  </wsdl:service>
</wsdl:definitions>
```

When generating WSDLs, the manner in which the WSDLs are configured (and therefore the clients stubs are generated) may vary based on the intent of the programmer. For example, a single WSDL may be designed to generate clients stubs for all services/functions of media distribution system 18. Alternatively, separate WSDLs may be made available for each service/function available within media distribution system 18. For example, a first WSDL may be made available to generate a client stub for the playback services/functions of media distribution system 18; a second WSDL may be made available to generate a client stub for the account management services/functions of media distribution system 18; a third WSDL may be made available to generate a client stub for the library management services/functions of media distribution system 18; a fourth WSDL may be made available to generate a client stub for the search services/functions of media distribution system 18; and a fifth WSDL may be made available to generate a client stub for the metadata services/functions of media distribution system 18.

Once the appropriate clients stubs (e.g., client stub 208) are generated to allow the client electronic device (e.g., personal media device 12, 38, personal digital assistant 40, and cellular telephone 42) to access the various services/functions of media distribution system 18, the client electronic device may be capable of: e.g., browsing/searching 250 file catalog 206; identifying 252 one or more media data files chosen from the plurality of media data files 204; receiving 254 a data request, using a standardized protocol, from a client electronic device; and providing 256 data, in response to the received data request, to the client electronic device in a third party usable format.

RPC Communication:

As discussed above, SOAP may use the RPC (i.e., Remote Procedure Protocol) process, in which a first network node (e.g. personal media device 38) sends a request message to another network node (e.g., computer 28), and the second network node (e.g., computer 28) sends a response message to the first network node (e.g., personal media device 38).

The RPC process typically starts on the client side (e.g., within device application 64). Device application 64 may call client stub 202 which, as described above, is generated (typically using WSDLs) to allow access to the various services/functions of media distribution system 18. Typically, instead of containing code that implements the services/functions, client stub 202 retrieves the required parameters from device application 64 and provides them to client runtime library 210. The parameters obtained from device application 64 may e.g., define search terms for use when browsing/searching 250 file catalog 202, identify 252 one or more media data files 200 for download, request or transmit metadata from or to computer 28, add or remove an entry to or from a user's library, or set up or cancel a subscription account, for example.

Client runtime library 210 may translate the parameters (as obtained from device application 64) into an NDR (i.e., Network Data Representation) formatted message 212. Message 212 may be transmitted using standardized protocol 214 (e.g., SOAP) to computer 28 (i.e., the computer that executes media distribution system 18) via network 30, 32. Client runtime library 210 may be an object library of routines that supports the functionality of client stub 202.

When computer 28 receives 254 NDR message 212 from the client electronic device, server runtime library 216 may accept NDR message 212 and call server stub 200. Server stub 200 may retrieve the parameters included within message 212 and convert them from the network transmission format (i.e., the NDR format) to a format usable by computer 28. Once converted, server stub 200 may call the requested service/function within media distribution system 18.

Once the requested service/function within media distribution system 18 is executed, one or more output parameters may be generated (on computer 28). The output parameters generated by media distribution system 18 may e.g., define search results, acknowledge receipt of a download request, or acknowledge receipt of metadata, for example.

Server runtime library 216 may translate the output parameters (as generated by media distribution system 18) into an NDR-formatted message 218. Message 218 may be provided 256 (i.e., using standardized protocol 220 (e.g., SOAP)) to the client electronic device (e.g., personal media device 12, 38, personal digital assistant 40, or cellular telephone 42) via network 30, 32. Server runtime library 216 may be an object library of routines that supports the functionality of server stub 200.

When the client electronic device receives NDR message 218 from computer 28, client runtime library 210 may accept NDR message 218 and call client stub 202. Client stub 202 may retrieve the output parameters included within message 218 and convert them from the network transmission format (i.e., the NDR format) to a format usable by the client electronic device.

As discussed above, the data provided to the client electronic devices may be provided in a third party usable format (i.e., a standardized format that is usable by third party applications). An example of such a format is XML. Accordingly, one or more of messages 212, 218 may be XML-based messages processable by various applications (e.g., a web browser).

A number of implementations have been described. Nevertheless, it will be understood that various modifications may be made. Accordingly, other implementations are within the scope of the following claims.

What is claimed is:

1. A media distribution system comprising:
a media repository configured to store a plurality of media data files;
a file catalog for identifying one or more of the plurality of media data files; and
an application program interface configured to enable a user of a client electronic device to browse/search the file catalog and identify one or more media data files chosen from the plurality of media data files;
wherein the application program interface is further configured to:
receive a data request, using a standardized protocol, from the client electronic device; and
provide data, in response to the received data request, to the client electronic device in a third party usable format.

2. The media distribution system of claim 1 wherein the standardized protocol is chosen from the group consisting of:
Simple Object Access Protocol (SOAP); Java Script Object Notation (JSON); REpresentational State Transfer (REST); and extensible Markup Language Remote Procedure Protocol (XML-RPC).

3. The media distribution system of claim 1 wherein providing data, in response to the received data request, to the client electronic device in a third party usable format includes:
providing, to the client electronic device, a service description that describes how the client electronic device may communicate with the media distribution system.

4. The media distribution system of claim 3 wherein the service description is a Web Services Description Language (WSDL)

5. The media distribution system of claim 3 wherein the client electronic device is configured to:
process the service description to generate one or more client stubs for accessing the media distribution system.

6. The media distribution system of claim 1 wherein the application program interface includes one or more servers stubs that are configured to communicate with one or more client stubs.

7. A method comprising:
storing a plurality of media data files within a media repository;
identifying one or more of the plurality of media data files within a file catalog;
receiving a data request, using a standardized protocol, from a client electronic device;
providing data, in response to the received data request, to the client electronic device in a third party usable format; and
enabling a user of the client electronic device to browse/search the file catalog and identify one or more media data files chosen from the plurality of media data files.

8. The method of claim 7 wherein the standardized protocol is chosen from the group consisting of:
Simple Object Access Protocol (SOAP); Java Script Object Notation (JSON); REpresentational State Transfer (REST); and extensible Markup Language Remote Procedure Protocol (XML-RPC).

9. The method of claim 7 wherein providing data, in response to the received data request, to the client electronic device in a third party usable format includes:
providing, to the client electronic device, a service description that describes how the client electronic device may communicate with the media distribution system.

10. The method of claim 9 wherein the service description is a Web Services Description Language (WSDL)

11. The method of claim 9 wherein the client electronic device is configured to:
process the service description to generate one or more client stubs for accessing the media distribution system.

12. A computer program product residing on a computer readable medium having a plurality of instructions stored thereon which, when executed by a processor, cause the processor to perform operations comprising:
storing a plurality of media data files within a media repository;
identifying one or more of the plurality of media data files within a file catalog;
receiving a data request, using a standardized protocol, from a client electronic device;
providing data, in response to the received data request, to the client electronic device in a third party usable format; and
enabling a user of the client electronic device to browse/search the file catalog and identify one or more media data files chosen from the plurality of media data files.

13. The computer program product of claim 12 wherein the standardized protocol is chosen from the group consisting of:
Simple Object Access Protocol (SOAP); Java Script Object Notation (JSON); REpresentational State Transfer (REST); and extensible Markup Language Remote Procedure Protocol (XML-RPC).

14. The computer program product of claim 12 wherein the instructions for providing data, in response to the received data request, to the client electronic device in a third party usable format include instructions for:
providing, to the client electronic device, a service description that describes how the client electronic device may communicate with the media distribution system.

15. The computer program product of claim 14 wherein the service description is a Web Services Description Language (WSDL)

16. The computer program product of claim 14 wherein the client electronic device is configured to:
process the service description to generate one or more client stubs for accessing the media distribution system.
